(19) United States
(12) Patent Application Publication
(10) Pub. No.: US 2026/0358157 A1
(43) Pub. Date: Nov. 12, 2026

(54) DIGITAL LOAD LEVELING IN A MAGNETIC FLOWMETER

(71) Applicant: Micro Motion, Inc., Boulder, CO (US)

(72) Inventors: Tony Ciacciarelli, Lakeville, MN (US); Jared Dreier, Chaska, MN (US); Kirk Allan Hunter, Eden Prairie, MN (US); Scot Ronald Foss, Eden Prairie, MN (US); Kyle Joseph McBrady, Maple Plain, MN (US)

(21) Appl. No.: 19/549,362

(22) Filed: Feb. 25, 2026

Related U.S. Application Data
(60) Provisional application No. 63/802,040, filed on May 8, 2025.

(51) Int. Cl. G01F 1/58

(52) U.S. Cl. CPC G01F 1/588

(57) ABSTRACT

A magnetic flowmeter for measuring flow rate of a process fluid includes a flow tube arranged to receive a flow of the process fluid therethrough. A magnetic coil is arranged proximate the flow tube to apply a magnetic field to the process fluid flowing through the flow tube. A pair of electrodes are electrically coupled to the process fluid in the flow tube and arranged to sense a voltage induced in the process fluid related to the applied magnetic field and a flow rate of the process fluid. Flowmeter circuitry is configured to apply an electric current to the magnetic coil and receive the voltage sensed by the pair of electrodes. An adaptive power supply circuit is configured to smoothen power drawn by the flowmeter circuitry from an input power source during a reversal in a direction of the electric current applied to the magnetic coil.

### CROSS-REFERENCE TO RELATED APPLICATION

The present application is based on and claims the benefit of U.S. provisional patent application Serial No. 63/802,040, filed May 8, 2025, the content of which is hereby incorporated by reference in its entirety.

### BACKGROUND

Embodiments of the present disclosure relate to magnetic flowmeters and, more specifically, to techniques for implementing load leveling in a magnetic flowmeter.

Precise and accurate flow control is desirable for a wide range of fluid processing applications, including bulk fluid handling, food and beverage preparation, chemistry and pharmaceuticals, water and air distribution, hydrocarbon extraction and processing, environmental control, and a range of manufacturing techniques utilizing thermoplastics, thin films, glues, resins and other fluid materials, for example. Flow rate measurement technologies used in each particular application depend upon the fluids involved, and on the relevant process pressures, temperatures and flow rates.

Exemplary flow rate measuring technologies include turbine devices that measure flow as a function of mechanical rotation, pitot sensors and differential pressure devices that measure flow as a function of the Bernoulli effect or pressure drop across a flow restriction, vortex and Coriolis devices that measure flow as a function of vibrational effects, and mass flowmeters that measure flow as a function of thermal conductivity. Magnetic flowmeters are distinguished from these technologies by characterizing a flow based on Faraday's Law, which depends upon electromagnetic interactions rather than mechanical or thermodynamic effects. In particular, magnetic flowmeters rely upon the conductivity of the process fluid, and the electromotive force (EMF) induced as the fluid flows through a region of magnetic field. Magnetic flowmeters function by creating a magnetic field inside a pipe using one or more external coils. Flow is measured using electrodes to measure a voltage as the liquid flows. The voltage generated is proportional to the velocity of the liquid.

Typically, during operation of the magnetic flowmeter, coil current is reversed at a regular rate to eliminate drift and provide a zero reference. A square wave is commonly used for this coil current direction change. Due to the inductive load of the coil, this can result in large power draws which can overload the power supply.

### SUMMARY

A magnetic flowmeter for measuring flow rate of a process fluid includes a flow tube arranged to receive a flow of the process fluid therethrough. A magnetic coil is arranged proximate the flow tube to apply a magnetic field to the process fluid flowing through the flow tube. A pair of electrodes are electrically coupled to the process fluid in the flow tube and arranged to sense a voltage induced in the process fluid related to the applied magnetic field and a flow rate of the process fluid. Flowmeter circuitry is configured to apply an electric current to the magnetic coil and receive the voltage sensed by the pair of electrodes. An adaptive power supply circuit is configured to smoothen power drawn by the flowmeter circuitry from an input power source during a reversal in a direction of the electric current applied to the magnetic coil.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an exemplary industrial process measurement system in accordance with embodiments of the present disclosure.

FIG. 2 is a simplified circuit block diagram of a digital load leveling magnetic flowmeter in accordance with one embodiment.

FIG. 3 is a simplified flow diagram of digital load leveling in a magnetic flowmeter in accordance with one embodiment.

FIG. 4 is a graph of coil current and input power versus time without digital load leveling.

FIG. 5 is a graph of coil current and input power versus time with digital load leveling.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations. The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form, in order to avoid obscuring the embodiments in unnecessary detail.

Magnetic flowmeters function by creating a magnetic field inside a pipe using external coils. Flow is measured using electrodes to measure a voltage as the liquid flows. The voltage generated is proportional to the velocity of the liquid. During operation of the magnetic flowmeter, coil current is reversed at a regular rate to eliminate drift and provide a zero reference. When the coil current direction through a coil of a magnetic flowmeter switches direction, the power stored in the coil begins to supply power back into the system. This extra power is in the form of a back electromotive force (EMF) and will cause the bus voltage used to power the flowmeter electronics to rise and the system input power draw to drop. Subsequently, after the power stored in the coil has been depleted, the input power to the device needs to drastically increase in order to continue to provide enough system power to complete the process of inverting the direction of the coil current. Without any load leveling, a coil current direction inversion can cause up to a 250% spike in input power. Further, when operating with a linear safety barrier, this surge of power can cause a current surge. This can cause the bus voltage to collapse, resulting in undesirable device performance.

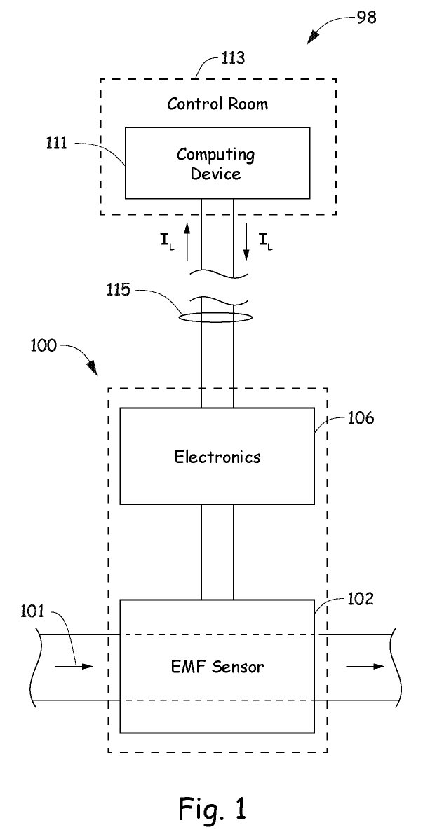

To address the above-noted problems, embodiments of the disclosure employ a digital load leveling control technique that smooths input power ripples caused by coil current direction inversion in a magnetic flowmeter. This allows a more consistent power draw from the external power supply. Further, when a safety barrier is used with an external power supply, this technique can prevent the system from drawing more instantaneous power from the safety barrier than the safety barrier can provide. Prior to providing specific implementation details regarding the digital load leveling, an industrial process management system is described below in connection with FIG. 1.

FIG. 1 is a simplified diagram of an exemplary industrial process measurement system 98 in accordance with embodiments of the present disclosure. The system 98 may be used in the processing of a material (e.g., process medium) to transform the material from a less valuable state into more valuable and useful products, such as chemicals, paper, food, etc. In general, the system 98 may be used with a wide variety of conductive fluids, which are generally characterized as liquids containing dissolved ions that can conduct electricity.

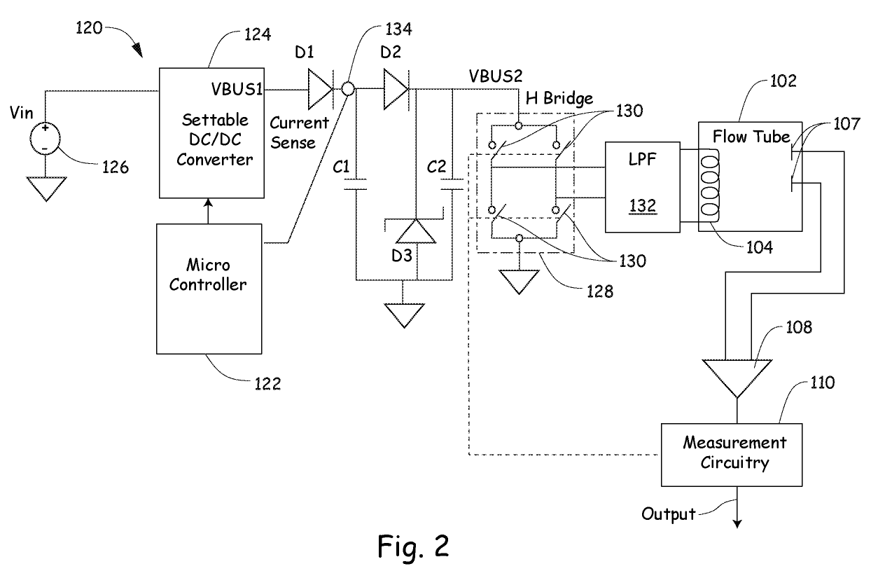

The system 98 includes a pulsed direct current (DC) magnetic flowmeter 100 that is configured to sense a flow rate of a process fluid flow 101, such as through a pipe or flow tube 102, for example. The magnetic flowmeter 100 includes an EMF sensor 107 (see FIG. 2) and flowmeter electronics 106. The sensor 107 is generally configured to measure or sense the flow rate of the fluid flow 101. The electronics 106 are generally configured to control the applied magnetic field to measure the flow rate, and optionally communicate the measured flow rate to an external computing device 111, such as a computerized control unit, which may be remotely located from the flowmeter 100, such as in a control room 113 of the system 98.

The electronics 106 may communicate with the external computing device 111 over a suitable process control loop. In some embodiments, the process control loop includes a physical communication link, such as a two-wire control loop 115, or a wireless communication link. Communications between the external computing device 111 and the flowmeter 100 may be performed over the control loop 115 in accordance with conventional analog and/or digital communication protocols. In some embodiments, the two-wire control loop 115 includes a 4-20 milliamp control loop, in which a process variable may be represented by a level of a loop current I_{L} flowing through the two-wire control loop 115. Exemplary digital communication protocols include the modulation of digital signals onto the analog current level of the two-wire control loop 115, such as in accordance with the HART® communication standard. Other purely digital techniques may also be employed including Foundation Fieldbus and Profibus communication protocols or Ethernet APL. Exemplary wireless versions of the process control loop include, for example, a wireless mesh network protocol, such as WirelessHART® (IEC 62591) or ISA 100.11a (IEC 62734), or another wireless communication protocol, such as WiFi, LoRa, Sigfox, BLE, or any other suitable protocol.

Power may be supplied to the magnetic flowmeter 100 from any suitable power source. For example, the magnetic flowmeter 100 may be wholly powered by the loop current I_{L} flowing through the control loop 115. One or more power supplies may also be utilized to power the process magnetic flowmeter 100, such as an internal or an external battery. An electrical power generator (e.g., solar panel, a wind power generator, etc.) may also be used to power the magnetic flowmeter 100, or charge a power supply used by the magnetic flowmeter 100.

FIG. 2 is a simplified block diagram of magnetic flowmeter 100 in which digital load leveling in accordance with an embodiment of the disclosure is implemented. Magnetic flowmeter 100 includes flow tube 102 configured to receive a flow of process fluid therethrough. A coil 104 is positioned in the flow tube 102 and is configured to apply a magnetic field to the moving process fluid. Electrodes 107 are carried in the flow tube 102 and are exposed to the process fluid. These electrodes 107 sense an EMF generated in response to the magnetic field applied to the moving process fluid. As discussed above, this EMF is proportional to the flow rate of the process fluid.

In the configuration illustrated in FIG. 2, a differential amplifier 108 is configured to sense and amplify the voltage difference generated between the two electrodes 107. In one configuration, the differential amplifier 108 includes an analog to digital converter which provides a digital output related to the sensed EMF. In either case, the output from element 108 is related to the sensed EMF which in turn is proportional to the flow rate of the process fluid.

Measurement circuitry 110 receives the output from differential amplifier 108 and provides an output related to the flow of the process fluid. The measurement circuitry 110 can be implemented in digital and/or analog circuitry and can include a microprocessor or the like. The microprocessor may perform further signal processing of the measured differential voltage to establish a flow rate measurement of the flow rate of the process fluid flow 101. In one configuration, the output from measurement circuitry 110 is of the type used in a process control environment. For example, as discussed above, the output can comprise an output on a two-wire process control loop including, for example, a 4-20 mA process control loop. The control loop may operate in accordance with the HART® communication protocol, a Fieldbus protocol, or other hardwired protocol. Further, the process control loop can also comprise a wireless control loop in which signals are communicated wirelessly. In some configurations, the same process control loop is used to provide power to the magnetic flowmeter 100.

The current applied to the coil 104 of the magnetic flow tube 102 is controlled by adaptive power supply circuitry 120. As discussed herein, adaptive power supply circuitry 120 operates to provide digital load leveling.

The adaptive power supply circuitry 120 includes a controller or microcontroller 122, which can be implemented in digital and/or analog circuitry and can include a microprocessor or the like, and a settable DC/DC converter 124 that is coupled to that microcontroller 122. Microcontroller 122, which in some embodiments may be an adaptive PID (proportional, integral, derivative) controller, is configured to track the system input power draw (e.g., power drawn from power supply 126 in FIG. 2) and to update bus voltage VBUS1 via settable DC/DC converter 124. The voltage VBUS1 is connected to an H-bridge driver 128 through diodes D1 and D2. Diodes D1 and D2 are connected to electrical ground through capacitors C1 and C2, respectively. Further, a clamping diode (e.g., Zener diode) D3 may be included in the circuit and connected in a manner shown in FIG. 2. The H-bridge driver 128 includes switches 130 which may be controlled by measurement circuitry 110 in accordance with known techniques. By alternating operation of switches 130 on either side of the H-bridge 128, the direction of the current applied to the coil 104 through a low pass filter 132 can be switched.

When the coil current inversion begins, it initiates back EMF generation in the coil 104. As back EMF is generated, charge begins to be added to capacitor C2 and VBUS2 begins to increase. In other words, the coil 104 begins to supply power into the system. As noted above, the microcontroller 122 tracks the system input power draw and increases the bus voltage level VBUS1 to match the bus voltage rise due to the back EMF provided by the coil 104. To enable microcontroller 122 to determine and track the system input power draw, current sensed by sensor 134 and VBUS1 and/or VBUS2 values may be provided to microcontroller 122. In the interest of simplification, voltage sensors to sense VBUS1 and/or VBUS2 are not show in FIG. 2. In one embodiment, microcontroller 122 calculates a constant input power draw target by using VBUS1 and current sense 134 measurements before the coil current inversion. Microcontroller 122 may also employ VBUS1 and current sense 134 values to determine instantaneous input power draw. During coil 104 current inversion, microcontroller 122 tracks the difference between the constant input power draw target and the instantaneous power drawn. As indicated above, microcontroller 122 may be an adaptive PID controller or the like, and therefore the adaptive controller gain acts on the difference between the constant input power draw target and the instantaneous power drawn and outputs a voltage value as a function of that difference. The voltage value output by the microcontroller 122 is provided to the settable DC/DC converter 124, which in turn updates VBUS1 with the received voltage value. This increases power drawn from power supply 126 to counter the decrease in power drawn due to back EMF, and charge is added to C1.

Once the power stored in the coil 104 due to back EMF is exhausted, microcontroller 122 begins to decrease the coil driver bus voltage level VBUS1. This allows the system to use the power stored in the capacitor C1 to finish the coil 104 current inversion process without having to draw in extra power from the external power supply 126.

At the end of the digital load leveling control process for the present coil current inversion cycle, a final bus voltage output of the microcontroller 122 is utilized by the microcontroller 122 to determine if too much or too little power was drawn into the system during the load leveling control process. More specifically, microcontroller 122 calculates a difference between a steady-state bus voltage for the present coil current inversion cycle and the final/end bus voltage output of the microcontroller 122. If too little power was brought into the system (i.e., if the end bus voltage is less than the steady-state bus voltage) the adaptive gain (e.g., adaptive PID controller gain) of the microcontroller 122 is automatically increased, which will bring in more power to the system on the next load leveling cycle, and the bus voltage level VBUS1 is slowly increased by microcontroller 122 back to a steady-state target to prevent large input power spikes. If too much power was brought into the system (i.e., if the end bus voltage is greater than the steady-state bus voltage), the adaptive gain of the microcontroller 122 is automatically reduced to bring in less power on the next load leveling cycle, and the bus voltage level VBUS1 is set to a steady-state value.

At the completion of the digital load leveling control process, the peak driver bus voltage across the capacitor C2 during the control process (peak VBUS2) is measured/identified by microcontroller 122. Alternatively, the peak driver bus voltage across the capacitor C1 during the control process (peak VBUS1) may be identified by microcontroller 122. The peak driver bus voltage should be below the maximum voltage allowed by the clamping diode D3 in order to prevent the clamping diode from siphoning off extra system power. The measured peak driver bus voltage is compared to a desired voltage limit, and the steady state of the coil driver bus voltage is adjusted so that, during the next load leveling control cycle, the back EMF from the coil and the extra voltage from the microcontroller 122 does not exceed the desired voltage limit. The desired voltage limit may be a factory configurable value and is stored in non-volatile memory (not shown). In some embodiments, the non-volatile memory may be a read-only memory (ROM), which can be written to only once. In other embodiments, the non-volatile memory may be updatable to provide the flexibility to be able to change the desired voltage limit if needed. Limiting the bus voltage based on the desired voltage limit allows the same flowmeter electronics (e.g., flowmeter circuitry including elements such as 108, 110, 128, 130, 132, D1, D2, D3, C1 and C2 of FIG. 2) to be connected to flow tubes with different inductances and allows them to perform at their highest power levels automatically without going over a conducting voltage of the clamping diode (e.g., Zener diode) D3. The load leveling process and the automatic bus voltage adjustment are two separate functions that both used the settable DC/DC converter 124 to automatically deliver the maximum power that the flowmeter electronics can deliver regardless of what flow tube is connected.

In summary, with the digital load leveling technique of the present disclosure, an adaptive PID controller is implemented to obtain optimal input power performance regardless of the load on the magnetic flowmeter circuit. Further, with such digital load leveling, the steady-state voltage can be adjusted during operation in order to compensate for hardware variations between devices and process temperature variations so as to provide consistent device performance. This also benefits flow auto-zero and smart meter verification for better device performance. This technique can also be implemented in other devices that have large periodic current draws.

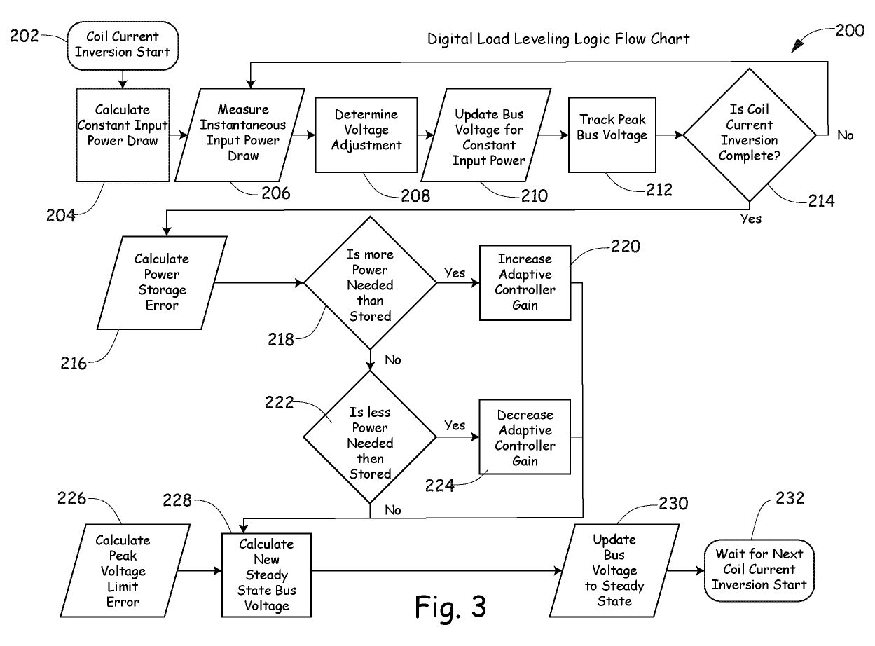

FIG. 3 is a simplified flow diagram 200 of digital load leveling in a magnetic flowmeter in accordance with one embodiment. In the digital load leveling method illustrated in flow diagram 200, coil current inversion starts at 202. As noted above, this initiates back EMF generation in a coil such as 104 of FIG. 2. A consequence of such back EMF generation is that power drawn from the supply will decrease without load leveling measures such as those described below.

At 204, a constant input power draw target is calculated. It should be noted that the constant input power draw target may be calculated prior to the coil current inversion. The calculation may be carried out using bus voltage and current (e.g., VBUS1 and current sense 134 measurements as in FIG. 2) before coil current inversion. At 206, instantaneous input power draw is measured during coil current inversion. Bus voltage and current (e.g., VBUS1 and current sense 134 measurements as in FIG. 2) may also be used to determine the instantaneous input power draw. At 208, a voltage adjustment value is determined. The voltage adjustment value may be determined by a controller gain (e.g., a gain of adaptive PID controller 122 of FIG. 2) that acts on the difference between the constant input power draw target determined at 204 and the instantaneous power draw determined at 206 and outputs the voltage adjustment value as a function of that difference. At 210, the bus voltage (e.g., VBUS1 of FIG. 2) is updated for constant input power. Here, the voltage adjustment value determined at 208 is provided to an electronic power supply that converts one DC voltage level to another (e.g., provided to the settable DC/DC converter 124 of FIG. 2), which in turn updates the bus voltage (e.g., VBUS1 of FIG. 2). This increases power drawn from the power supply (e.g., 126 of FIG. 2) to counter the decrease in power draw due to back EMF, and charge is added to a power storage element (e.g., capacitor C1 of FIG. 2). At 212, the peak bus voltage is tracked. This may involve, for example, tracking peak VBUS1 or peak VBUS2 by a microcontroller such as 122 of FIG. 2. At 214, a determination is made as to whether coil current inversion is complete. If coil connect inversion is not complete, control returns to 206 and 206-214 are repeated. If coil current inversion is complete, control is passed to 216.

At 216, a power storage error is calculated. At the end of the digital load leveling control process for the present coil current inversion cycle, the end bus voltage output of the adaptive PID controller is measured to determine if too much or too little of power was drawn into the system during the load leveling control process. The power storage error is calculated at 216 by determining a difference between a steady-state bus voltage for the present coil current inversion cycle and the end bus voltage output of the adaptive PID controller. At 218, a determination is made as to whether more power is needed than stored. More specifically, if the end bus voltage is less than the steady-state bus voltage, then more power is needed than stored and therefore the adaptive controller gain is increased at 220. If, at 218, it is determined that more power in not needed, 220 is not performed and control passes to 222. At 222, a determination is made as to whether less power is needed than stored. If the end bus voltage is less than the steady-state bus voltage, then the adaptive controller gain is decreased at 224. It should be noted that, at 220 and 224, the adaptive controller gain is adjusted automatically based on the determined difference between the end bus voltage and the steady-state bus voltage. In one embodiment, a piecewise function is utilized to automatically adjust the gain. Here, the difference between the end bus voltage and the steady-state bus voltage serves as the input to the piecewise function and gain increase/decrease step size is an output.

In method 200, 202-224 described above relate to load leveling and may utilize a settable DC/DC converter such as 124 of FIG. 2. The settable DC/DC converter, may also be utilized to carry out 226-230 described below, which relate to automatic bus voltage adjustments based on a predetermined peak voltage limit.

At 226, a peak voltage limit error is calculated. This calculation may be made by comparing the peak bus voltage (peak VBUS1 or peak VBUS2) obtained at 212 to a predetermined voltage limit. The steady-state of the coil driver bus voltage (also referred to herein as the steady-state bus voltage or simply steady-state voltage) is then adjusted based on the calculated peak voltage limit error so that, on a next load leveling process to be carried out during a next current reversal, the back EMF from the coil and the extra voltage from the adaptive PID controller do not exceed the voltage limit. In FIG. 3 , the adjustment of the steady-state bus voltage involves calculating a new steady-state bus voltage at 228 and updating the bus voltage to the new steady-state voltage at 230. Limiting the bus voltage based on the desired/predetermined voltage limit allows the same flowmeter electronics to be connected to flow tubes with different inductances and allows them to perform at their highest power levels automatically without going over a conducting voltage of a clamping diode (e.g., Zener diode D3 of FIG. 2 ). At 232, the process waits for the next coil current inversion. Control passes to back to 202 when the next coil current inversion begins.

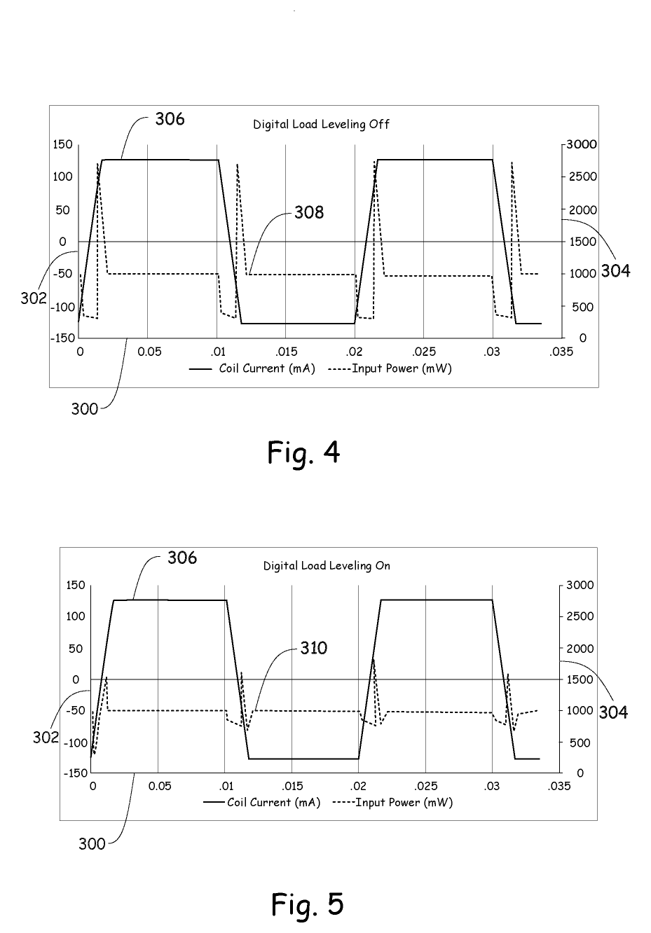

FIG. 4 is a graph of coil current and input power versus time without digital load leveling.

In FIG. 4, horizontal axis 300 represents time in in seconds (s), first vertical axis 302 represents current in milliamperes (mA) and second vertical axis 304 represents power in milliwatts (mW). Plot 306 shows the coil current, which is pulsed DC, and plot 308 shows the input power. As can be seen in FIG. 4, without digital load leveling, there is a substantial spike in input power each time there is an inversion of the coil current.

FIG. 5 is a graph of coil current and input power versus time with digital load leveling. In FIG. 5 , horizontal axis 300 and vertical axes 302 and 304 are the same as those of FIG. 4C . Also, the coil current plot 306 is the same as that of FIG. 4 . However, the spikes in input power plot 308 shown in FIG. 4 are absent in input power plot 310 of FIG. 5 due to the presence of digital load leveling of the type described in FIGS. 2 and 3 above.

Although the present invention has been described with reference to preferred embodiments, workers skilled in the art will recognize that changes may be made in form and detail without departing from the spirit and scope of the invention.

What is claimed is:

1. A magnetic flowmeter for measuring flow rate of a process fluid, comprising:
a flow tube arranged to receive a flow of the process fluid therethrough;
a magnetic coil arranged proximate the flow tube to apply a magnetic field to the process fluid flowing through the flow tube;
a pair of electrodes electrically coupled to the process fluid in the flow tube and arranged to sense a voltage induced in the process fluid related to the applied magnetic field and a flow rate of the process fluid;
flowmeter circuitry configured to apply an electric current to the magnetic coil and receive the voltage sensed by the pair of electrodes; and
adaptive power supply circuitry configured to smoothen power drawn by the flowmeter circuitry from an input power source during a reversal in a direction of the electric current applied to the magnetic coil.

2. The magnetic flowmeter of claim 1, wherein the adaptive power supply circuitry comprises an adaptive controller configured to track the power drawn by the flowmeter circuitry and to update a bus voltage provided to the flowmeter circuitry in response to a change in the power drawn by the flowmeter circuitry, thereby smoothening the power drawn by the flowmeter circuitry.

3. The magnetic flowmeter of claim 2, wherein the adaptive power supply circuitry further comprises a settable direct current to direct current (DC/DC) converter coupled to the adaptive controller, and wherein the adaptive controller is configured to update that bus voltage by setting an output voltage value of the settable DC/DC converter.

4. The magnetic flowmeter of claim 2, wherein the adaptive controller comprises an adaptive proportional, integral, derivative (PID) controller.

5. The magnetic flowmeter of claim 4, wherein, in response to the reversal in the direction of the electrical current applied to the magnetic coil, the magnetic coil generates a back electromotive force (EMF) that impedes the reversal of the electric current in the coil, and wherein the adaptive PID controller is configured to track the power drawn by the flowmeter circuitry during the generation of the back EMF and to update the bus voltage provided to the flowmeter circuitry between a start of the reversal of the electrical current in the magnetic coil and an end of the reversal of the electrical current in the magnetic coil.

6. The magnetic flowmeter of claim 5, wherein the adaptive PID controller is configured to determine a difference between an output voltage of the adaptive PID controller at the end of the inversion of the electrical current in the magnetic coil and a steady-state bus voltage for a present coil current inversion cycle.

7. The magnetic flowmeter of claim 6, wherein, if the output voltage of the adaptive PID controller at the end of the inversion of the electrical current in the magnetic coil is less than the steady-state bus voltage, the gain of the adaptive PID controller is increased as a function of the difference between the output voltage of the adaptive PID controller at the end of the inversion of the electrical current in the magnetic coil and the steady-state bus voltage.

8. The magnetic flowmeter of claim 6, wherein, if the output voltage of the adaptive PID controller at the end of the inversion of the electrical current in the magnetic coil is greater than the steady-state bus voltage, the gain of the adaptive PID controller is decreased as a function of the difference between the output voltage of the adaptive PID controller at the end of the inversion of the electrical current in the magnetic coil and the steady-state bus voltage.

9. The magnetic flowmeter of claim 5, wherein the adaptive PID controller is configured to determine a difference between a peak bus voltage and a predetermined voltage limit.

10. The magnetic flowmeter of claim 9, wherein the adaptive PID controller is further configured to determine a steady state-state bus voltage for a next coil current inversion cycle as a function of the determined difference between the peak bus voltage and the predetermined voltage limit.

11. A method for measuring flow of a process fluid using a magnetic flowmeter, comprising:
receiving a flow of the process fluid through a flow tube;
applying, by a magnetic coil arranged proximate the flow tube, a magnetic field to the process fluid flowing through the flow tube;
sensing, by a pair of electrodes electrically coupled to the process fluid in the flow tube, a voltage induced in the process fluid related to the applied magnetic field and a flow rate of the process fluid;
applying, by flowmeter circuitry, an electric current to the magnetic coil and receiving the voltage sensed by the pair of electrodes; and
smoothening, by adaptive power supply circuitry, power drawn by the flowmeter circuitry from an input power source during a reversal in a direction of the electric current applied to of the magnetic coil.

12. The method of claim 11, wherein the smoothening the power drawn by the flowmeter circuitry comprises tracking, by an adaptive proportional, integral, derivative (PID) controller of the adaptive power supply circuitry, the power drawn by the flowmeter circuitry and updating a bus voltage provided to the flowmeter circuitry in response to a change in the power drawn by the flowmeter circuitry.

13. The method of claim 12, wherein the updating of the bus voltage of the adaptive power supply circuitry further comprises setting, by the adaptive PID controller, an output voltage value of a settable DC/DC converter coupled to the adaptive PID controller.

14. The method of claim 12, wherein the tracking the power drawn by the flowmeter circuitry is carried out when, in response to the reversal in the direction of the electrical current applied to the magnetic coil, the magnetic coil generates a back electromotive force (EMF) that impedes the reversal of the electric current in the coil.

15. The method of claim 14 and further comprising updating, during the generation of the back EMF, the bus voltage provided to the flowmeter circuitry between a start of the reversal of the electrical current in the magnetic coil and an end of the reversal of the electrical current in the magnetic coil.

16. The method of claim 15 and further comprising determining, by the adaptive PID controller, a difference between an output voltage of the adaptive PID controller at the end of the inversion of the electrical current in the magnetic coil and a steady-state bus voltage for a present coil current inversion cycle.

17. The method of claim 16, wherein, if the output voltage of the adaptive PID controller at the end of the inversion of the electrical current in the magnetic coil is less than the steady-state bus voltage, increasing the gain of the adaptive PID controller as a function of the difference between the output voltage of the adaptive PID controller at the end of the inversion of the electrical current in the magnetic coil and the steady-state bus voltage.

18. The method of claim 16, wherein, if the output voltage of the adaptive PID controller at the end of the inversion of the electrical current in the magnetic coil is greater than the steady-state bus voltage, decreasing the gain of the adaptive PID controller as a function of the difference between the output voltage of the adaptive PID controller at the end of the inversion of the electrical current in the magnetic coil and the steady-state bus voltage.

19. The method of claim 15 and further comprising determining, by the adaptive PID controller, a difference between a peak bus voltage and a predetermined voltage limit.

20. The method of claim 19 and further comprising determining, by the adaptive PID controller, a steady state-state bus voltage for a next coil current inversion cycle as a function of the determined difference between the peak bus voltage and the predetermined voltage limit.

21. A magnetic flowmeter for measuring flow rate of a process fluid, comprising:
a flow tube arranged to receive a flow of the process fluid therethrough;
a magnetic coil arranged proximate the flow tube to apply a magnetic field to the process fluid flowing through the flow tube;
a pair of electrodes electrically coupled to the process fluid in the flow tube and arranged to sense a voltage induced in the process fluid related to the applied magnetic field and a flow rate of the process fluid;
flowmeter circuitry configured to apply an electric current to the magnetic coil and receive the voltage sensed by the pair of electrodes; and
adaptive power supply circuitry configured to prevent a bus voltage of the flowmeter circuitry from exceeding a predetermined voltage limit.

22. The magnetic flowmeter of claim 21, wherein the adaptive power supply circuitry is further configured to smoothen power drawn by the flowmeter circuitry from an input power source during a reversal in a direction of the electric current applied to the magnetic coil.
